(19) United States
(12) Patent Application Publication
(10) Pub. No.: US 2002/0091577 A1
(43) Pub. Date: Jul. 11, 2002

(54) Wireless retail purchasing system using a mobile computing device

(76) Inventors: Travis J. Parry, Boise, ID (US); Bryan K. Carter, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/756,356

(22) Filed: Jan. 8, 2001

(51) Int. Cl. G06F 17/60

(52) U.S. Cl. 705/26; 455/555; 455/556

(57) ABSTRACT

A method and system enables consumers to wirelessly and electronically identify retail purchases and wirelessly transact those purchases. The method includes use of a mobile computing device to wirelessly, electronically obtain a menu of items for sale from a retail unit, select items from the menu, and send a request from the mobile computing device to the retail unit to purchase the selected items. The method optionally includes electronically sending payment for the requested purchase to the retail unit.

### THE FIELD OF THE INVENTION

The present invention relates generally to mobile computing devices and in particular to a system and method of wireless retail purchasing using a mobile computing device.

### BACKGROUND OF THE INVENTION

Mobile computing devices provide many traditional functions such as calendars, word processing, financial tracking, spreadsheets, address books and to-do lists. More recently, these devices also provide functions such as wireless internet capability with web browsing, e-mail and news services, etc. Perhaps the most prominent mobile computing devices are personal digital assistants (PDAs) which provide all of these functions in a small, highly portable computing module. Of course, laptop and notebook computers also can provide these functions in a slightly larger device. Mobile phones also permit wireless communication with e-mail and news service functions among their traditional functions.

Mobile computing devices, and particularly PDAs, have been revolutionary in allowing a user to electronically organize and maintain their personal or business information. However, most of the activity involving a PDA only actively and directly affects the user of the PDA. Information in the PDA impacts the surrounding environment, such as businesses or people, only in a passive and indirect manner. Only when the user chooses to contact a person or a business does the information from the PDA begin to directly and actively affect another person or business. For example, a user can operate the calendar, spreadsheet, or address book of the PDA without impacting anyone else. Even when a PDA is used to send an e-mail, no other person is impacted until the intended recipient retrieves their e-mail, which usually occurs well after the e-mail was sent. Finally, even the most advanced web browsing capabilities of a PDA limit interaction of the PDA largely to persons and businesses on the World Wide Web. Accordingly, mobile computing devices such as PDAs are relegated to primarily being passive information storage devices with very limited ability to interact with the external world.

Ironically, with all of these highly technological advances to simplify our day, daily communication issues in the real world remain vexing. For example, a consumer ordering food from a drive-up window must wait in a line of cars to see a menu. Upon arrival at the posted menu, the consumer awkwardly shouts into a microphone to place their order. With poor acoustics, this process commonly requires repeating some or all of the previously recited order to complete the transaction. While drive-up ordering at restaurants is popular, the process is clearly unsatisfying to consumers as evidenced by the plethora of jokes and skits poking fin at the drive-up ordering communication process.

Similarly, consumers frequently enter in a retail environment such as a retail shopping center where everything they need is around them, but the consumer must use a trial and error process of entering multiple stores to find the desired item. Much time is wasted retracing paths within the mall to find and purchase all of the desired items. With the advent of convenient retail shopping on the internet, the inefficient searching process in retail shopping centers may keep customers at home rather then venture out to do their shopping. With these cultural changes, retail shopping centers have an interest in reducing obstacles to customers quickly finding their desired items.

Accordingly, while mobile computing devices have captured our attention for organizing daily activities, consumers still experience frustration and wasted time in retail purchasing.

### SUMMARY OF THE INVENTION

A method of the present invention permits wirelessly, electronically identifying an on-site or near-site retail purchase from a retail unit using a mobile computing device. The method includes wirelessly, electronically, and directly communicating between the mobile computing device and the retail unit to perform the following actions. The mobile computing device receives a listing from the retail unit. The mobile computing device transmits a purchase request to the retail unit to order selected items from the listing.

In another embodiment, the method is carried out in a multiple retail unit center having multiple retail units. A request is sent from the mobile computing device to the retail units within the retail unit center to identify select items available for purchase from the retail units within the retail center.

In another embodiment, the present invention provides a system for identifying and transacting a wireless electronic on-site retail purchase. The system includes a mobile computing device. A retail unit is provided including a wireless communication module for direct wireless electronic communication with the mobile computing device. A direct wireless electronic communication link is established between the mobile computing device and the retail unit. The direct wireless electronic communication link is activated by at least one of selective activation by the mobile computing device and by automatic activation upon the mobile computing device and the retail unit upon arrival of the computing device upon the premises of the unit.

In another embodiment, the present invention provides a wireless purchasing system. The wireless purchasing system includes a communication module located at a retail unit. A wireless appliance is configured to establish a communication link with the retail unit via the communication module, receive a listing of items from the retail unit, transmit a purchase request to the retail unit of ordered selected items from the listing, and receive a confirmation of the ordered selected items.

### BRIEF DESCRIPTION OF THE DRAWINGS

FIG. 1 is a block diagram illustrating one exemplary embodiment of a method and system of the present invention for wirelessly identifying and/or transacting on-site and near-site retail purchases using a mobile computing device.

FIG. 2 is a flow diagram of a method of wirelessly identifying and/or transacting a retail purchase as seen from a consumer's perspective, according to one exemplary embodiment of the present invention.

FIG. 3 is a flow diagram of a method of wirelessly identifying and/or transacting a retail purchase as seen from a retailer's perspective, according to one exemplary embodiment of the present invention.

FIG. 4 is a block diagram of a method and system of transacting a retail purchase at a drive-up ordering restaurant, according to one exemplary embodiment of the present invention.

FIG. 5 is a diagram illustrating one exemplary embodiment of a master screen viewable on a display of a mobile computing device during a retail transaction according to a system and method of the present invention.

FIG. 6 is a diagram illustrating one exemplary embodiment of a menu of items available for retail purchase that is viewable with a mobile computing device during a transaction under the method of the present invention.

FIG. 7 is a diagram illustrating one exemplary embodiment of a menu of payment options available for completing the retail purchase that is viewable with the mobile communication device in a method of the present invention.

FIG. 8 is a diagram of a method and system of wirelessly, electronically identifying and optionally transacting a retail purchase at a multiple unit retail center, according to one exemplary embodiment of the present invention.

FIG. 9 is a flow diagram of a method of identifying and transacting a wireless electronic direct retail purchase within the system of FIG. 8, according to one exemplary embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

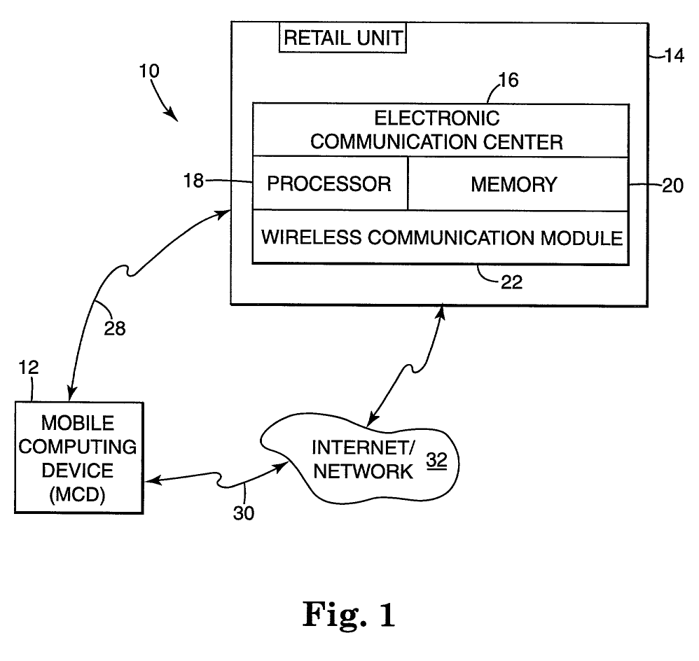

In FIG. 1, one embodiment of a wireless purchasing system according to the present invention is shown generally at 10. The system 10 provides a method of identifying and/or transacting a wireless, electronic on-site or nearsite retail purchase, according to an embodiment of the present invention. System 10 generally includes mobile computing device 12 and retail unit 14 having electronic communication center 16. Electronic communication center 16 further includes processor 18, memory 20, and wireless communication module 22. Mobile computing device 12 communicates with retail unit 14 via direct wireless pathway 28 or indirect wireless pathway 30 using internet/network 32.

Mobile computing device 12 preferably comprises a mobile or portable computing device capable of electronic wireless communication and having a processor and memory such as a personal digital assistant (PDA), handheld computer, laptop computer, notebook computer, or wireless appliance. As commonly known, these devices may include a keypad or stylus for controlling their operation and entering information, as well as a viewable display, and sound. The device may also carry a microphone for use with known voice recognition equipment and software included in the device. Finally, a mobile communication device such as an advanced mobile or cellular phone which has the same features as mobile computing device 12 can operate as mobile computing device 12.

Electronic communication center 16 of retail unit 14 preferably is a general purpose computer that is capable of wireless electronic communication via wireless communication module 22. The computer preferably has voice recognition capability, as well as a display, a microphone, and a keyboard, all of which are used for entering and retrieving information. Electronic communication center 16 includes, or is linked to, a more general system of retail unit for tracking finances, inventory, production, and sales of retail unit 14. This more general system permits ordering and purchasing information related to a method and system of the present invention to be synchronized with the general operation of retail unit 14.

Wireless communication between retail unit 14 and mobile computing device 12 is accomplished using one or more known communication and application protocols such as Wireless Application Protocol (WAP), Bluetooth, Infrared (IrDA), 802.11, as well as other communication and application protocols known to those skilled in the art. Each of these protocols is incorporated herein by reference. Mobile computing device 12 and electronic communication center 16 of retail unit 14 each include communication hardware and software known in the art for implementing these protocols.

Of particular interest are protocols such as Bluetooth which permit direct radio or beamed communication 28 between compatible devices that operate independently of a network and independently of the internet or a telecommunications network 30. This feature permits direct one-on-one communication between a business and a consumer without any communication intermediary or financial intermediary. In the example of the Bluetooth protocol, the communication link preferably is established by the mere presence of each respective device (e.g., mobile computing device 12 and electronic communication center 16) in close proximity to each other. This instant synchronization enables users to immediately communicate with each other without taking time to manually establish a connection or communication link. Of course, mobile computing device 12 also can retain selective control of when any communications link is established or recognized so that undesirable communication linking to mobile computing device 12 is prevented. Finally, mobile computing device 12 also can communicate with retail unit 14 through more conventional indirect routes such as wireless link 30 to network 30 (e.g., an intranet or internet network, such as the Internet).

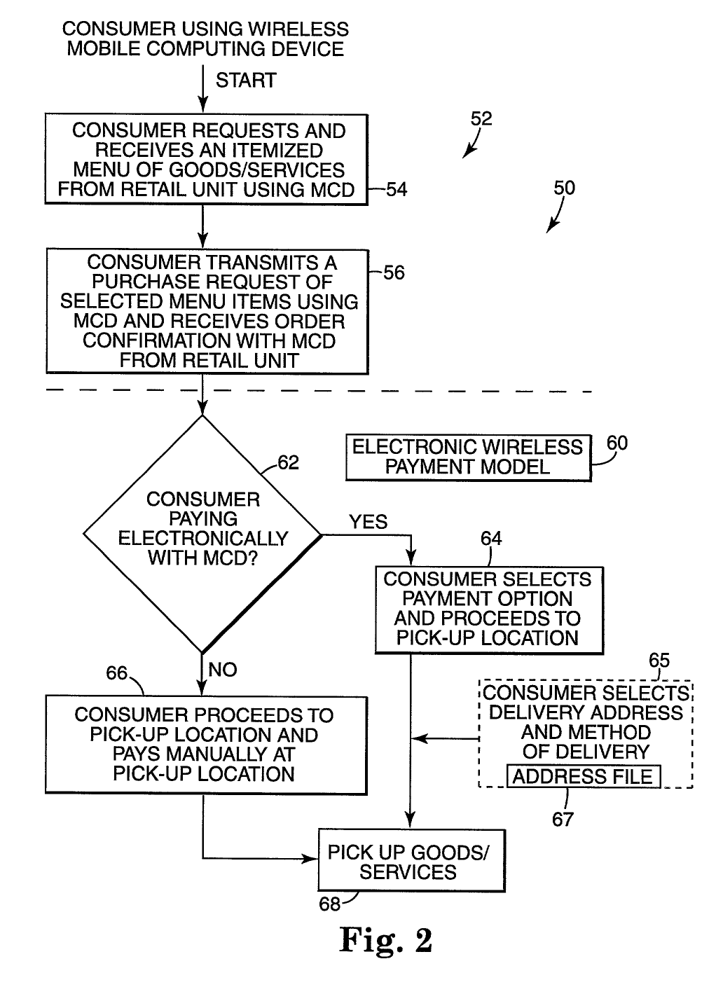

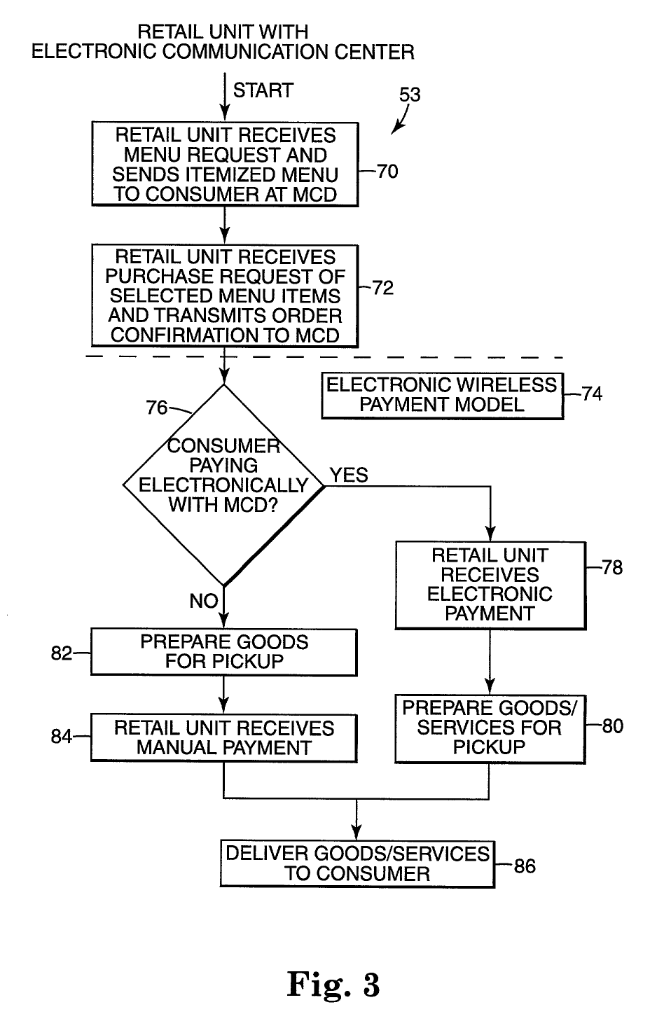

A method of transacting retail purchases 50 using system 10 according to an embodiment of the present invention is shown in FIGS. 2 and 3. FIG. 2 represents a consumer pathway 52 in the transaction while FIG. 3 represents a retailer's pathway 53 in the transaction. System 10 is used to carry out this method so that all communication along the pathways is electronic, wireless and preferably directly between the consumer via mobile computing device 12 and retail unit 14.

As shown by the flow diagram in FIG. 2, consumer pathway 52 starts with a consumer using mobile computing device 12 to request and receive an itemized menu of goods/services from retail unit 14 (step 54). The consumer uses mobile computing device 12 to transmit a purchase request of selected menu items and then receives with mobile computing device 12 a confirmation of the order from retail unit 14 (step 56). Steps 54 and 56 of consumer pathway 52 comprise the most basic elements of the method of the present invention, with additional steps not being necessary but optionally provided to further streamline the retail transaction.

If the consumer desires to complete additional steps of the transaction electronically, then the next step in the method includes paying for the ordered items using electronic wireless payment model 60. In model 60, the consumer has the option of paying electronically with mobile computing device 12 (step 62). If electronic payment is desired using mobile computing device 12, the consumer selects an electronic payment option with mobile computing device 12 and proceeds to a pickup location at retail unit 14 (step 64). Alternatively, if the consumer is not paying electronically with mobile computing device 12, the consumer proceeds to the pickup location and pays for the items manually at the pickup location (step 66). Whether paying electronically or manually, a final step includes picking up the goods or services at the retail unit 14 (step 68).

In addition, step 64 optionally includes step 65 in which the consumer further specifies a delivery address (e.g., home, work, gift recipient) to which the goods will be delivered or at which the services will be performed, as well as specifying the manner of delivery such as packaging instructions (e.g., gift wrapping). The delivery address is included in electronic address/delivery file 67 that is sent with electronic payment instructions to retail unit 14. The consumer also can specify a method of delivery such as direct delivery (e.g., for pizza delivery, furniture/appliance truck delivery) or courier (e.g., FedEx, UPS, US Postal, etc.) with various speed options (overnight, second day, etc.).

Electronic payment can be accomplished through one or more known wireless secure electronic payment systems such as those systems available from epaywireless, billpay, etc, which permit credit card payment, electronic checks, electronic funds transfer, instant invoicing and credit account payment. While most of these systems use the internet, retail unit 14 also can have its own credit card account or electronic check system for receiving payments directly from mobile computing device 12 as well as optionally interfacing with a financial institution or financial services company. While electronic payment is convenient, the method of the present invention can be practiced without electronic payment since the retail purchase will be consummated on-site permitting payment to be made with cash and other traditional payment methods (e.g., check, credit card) that are typically available in a face-to-face transaction.

As shown in FIG. 3, retail pathway 53 in the method of the present invention starts with retail unit 14 receiving a menu request from the consumer via mobile computing device 12 and retail unit 14 sending an itemized menu to the consumer mobile computing device 12 (step 70). Next, retail unit 14 receives a purchase request from the consumer via mobile computing device 12 and retail unit 14 responds by transmitting an order confirmation to mobile computing device 12 (step 72). As with consumer pathway 52, retail unit 14 can elect to continue the transaction in a wireless electronic mode in the method of the present invention, or elect to complete the transaction manually.

Retail pathway 53 further includes an electronic wireless payment model 74. In model 74, retail unit 14 has the option of receiving electronic payment from mobile computing device 12 (step 76). If electronic payment is made with mobile computing device 12, retail unit 14 receives electronic payment (step 78) and then prepares the goods/services for pick up by the consumer (step CD). Alternatively, if the manual payment is required, then retail unit 14 prepares the goods or services for pick up (step 82) and then receives manual payment (step 84). As a final step, retail unit 14 delivers the goods or services to the consumer (step 86).

Accordingly, with a method and system of the present invention, a mobile computing device is used to simplify on-site or near on-site retail transactions between the consumer and the retail unit. In the method, wireless electronic communication is used to: (1) identify what items are available or desired for potential purchase; (2) what items selected for purchase; and (3) optionally complete the purchase with electronic payment. Accordingly, in a method of the present invention, mobile computing devices will more directly interact with and impact the external world instead of being relegated to their conventional role as a generally passive information storage device. Consumers will benefit by experiencing quicker and more pleasant retail purchasing.

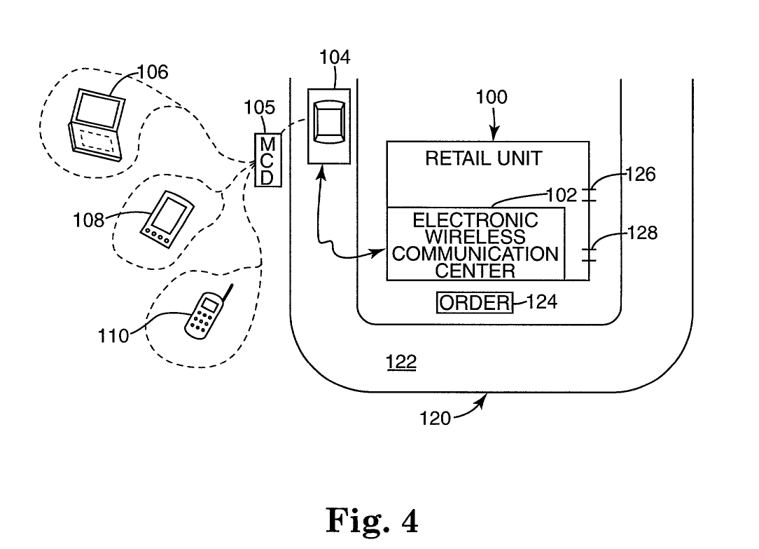

FIG. 4 illustrates one exemplary embodiment of a drive-up restaurant ordering system for carrying out a method of the present invention of identifying and/or transacting wireless, on-site retail purchases. As shown in FIG. 4, retail unit 100 includes electronic wireless communication center 102 and vehicle 104 carries a consumer having mobile computing device 105 such as laptop 106, personal digital assistant (PDA) 108, and/or smart mobile phone 110. Mobile computing device 105 has generally the same features and attributes as mobile computing device 12 described in association with FIGS. 1-3. Retail unit 100 and electronic communication center 102 include generally the same features and attributes as retail unit 14 and electronic communication center 16 described in association with FIGS. 1-3. In one aspect, mobile computing device 105 is capable of being powered from or linked to an automobile or vehicle. In another aspect, the mobile computing device is manufactured as part of the vehicle control system.

Retail unit 100 further includes drive-up system 120 with driveway 122, curbside ordering station 124, pickup window 126 and payment window 128. A method of transacting a wireless on-site retail purchase between retail unit 100 and mobile computing device 105 is carried out generally with the steps described in FIGS. 2-3, with retail unit 14 and mobile computing device 12 being substituted by retail unit 100 and mobile computing device 105, respectively.

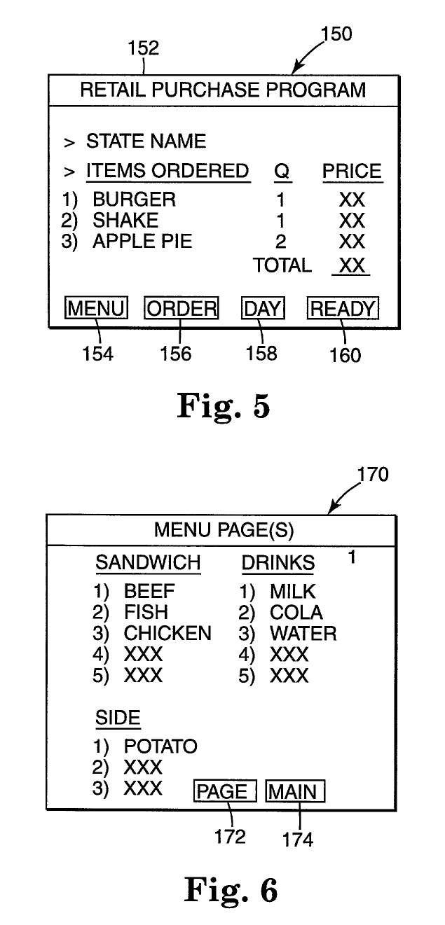

FIGS. 5-7 further illustrate operation of mobile computing device 105 in a method of the present invention. While FIGS. 5-7 use a restaurant as an example of retail unit 100, this detailed operation of mobile computing device 105 and retail unit 100 is applicable to other goods or service providers selling items other than food.

FIG. 5 is a diagram illustrating master screen 150 of a retail purchase program as shown on display 152 of mobile computing device 105 for implementing the method of the present invention. Master screen 150 is obtained by selecting the retail purchase program from among other general functions (e.g. calendar, spreadsheet, etc.) of mobile computing device 105. Master screen 150 governs basic communication and interaction between mobile computing device 105 and retail unit 100 during the retail transaction. Master screen 150 includes at least menu function 154, order function 156, pay function 158, and ready function 160, as well as any other functions suitable for particular types of retail transactions. Master screen 150 in the method of the present invention is not limited solely to four functions or to these particular functions.

Upon initial selection, master screen 150 will not list any store name, items or prices. By activating one of the function buttons (menu 154, order 156, pay 158, ready 160), further screens supporting the retail purchase program appear on display 152 for viewing and manipulation by the consumer. A similar master screen 150 will be viewed by retail unit 100 and may optionally include additional functions related to internal inventory, production, etc.

Once the consumer is on-site in driveway 122 or nearly on-site (i.e., nearsite) at retail unit 100, consumer activates menu function 154 on master screen 150 to simultaneously establish a direct communication link with retail unit 100 and to request a menu from retail unit 100. Alternatively, if one of the preferred communication protocols is supported by mobile computing device 105 and retail unit 100, a communication link is established automatically by the mere presence of mobile computing device 105 in close proximity to retail unit 100. Upon retail unit 14 responding to the request, master screen 150 of mobile computing device 105 displays the store name of retail unit 100. This feature confirms that the menu is available and has been downloaded into mobile computing device 105. The menu is viewable by further activating menu function 154 on master screen 150, which results in the active display of menu page 170 on mobile computing device 105 as shown in FIG. 6.

As shown in FIG. 6, menu page 170 displays a complete or partial listing of all items available for sale from the retail unit 100. Menu page 170 further includes a page function 172 and main function 174. Page function 172 permits the consumer to page through additional menu pages which list other items for sale. The consumer uses the keypad or stylus of mobile computing device 105 to highlight selected items on menu page 170 to be ordered. The selected items are then stored in memory as ordered items for later viewing on master screen 150. When selection of the desired items is complete, the consumer activates main function 174 to return to master screen 150.

If the consumer chooses to continue the transaction, the consumer activates order function 156 on master screen 150 to submit the order request to retail unit 100. Once retail unit 100 sends confirmation of the order to mobile computing device 105, order function 156 on master screen 150 is automatically highlighted or otherwise enhanced to alert the consumer that the order was confirmed. Alternative audio and/or visual cues can be used to confirm the order.

The consumer carries out the order selection process as shown in FIGS. 5 and 6 in place of conventional oral person-to-person communication with drive-up ordering station 124 at retail unit 100.

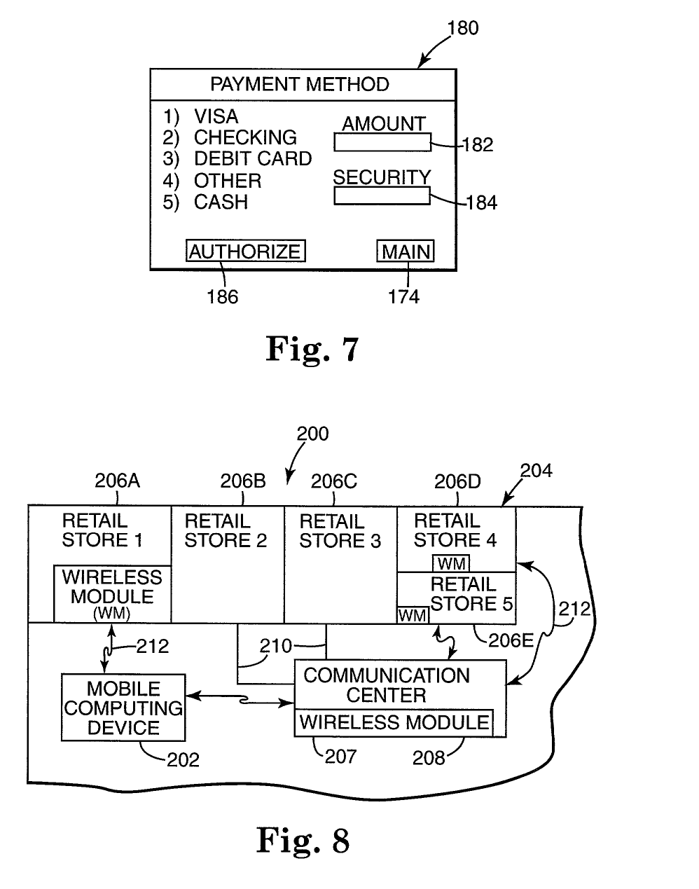

After receiving confirmation of the order, the consumer completes the transaction by making payment electronically, or optionally, makes payment manually at payment window 128 of retail unit 100. Where payment is made electronically, the consumer can proceed directly to pick-up window 126. To make an electronic payment, the consumer selects payment options page 180 as shown in FIG. 7 by activating pay function 158 on master screen 150. Payment page 180 includes a listing of the different types of payment that can be selected (credit, checking, debit card, cash/manual, other etc.) using mobile computing device 105. The cash/manual option will indicate to retail unit 100 that the consumer will not be paying electronically. Payment options page 180 further includes purchase amount 182 that is filled automatically from the order and security code 184 (such as a personal identification number or other code) that must be entered by the consumer via mobile computing device 105. Finally, payment page 180 includes authorize function 186 for sending authorization for electronic payment to retail unit 100 and main function 174 for returning to main screen 150 after completing payment. After payment is accepted by retail unit 14, pay function 158 on master screen 150 is highlighted or enhanced to alert the consumer that payment was accepted. Finally, whether payment is made electronically or manually, the ordered goods or services are picked up at window 126.

Consumers maneuver through the various pages on master screen 150 by activating selected functions using a stylus, keyboard, or voice recognition technology. Of course, pages other than those shown in FIGS. 5-7 optionally are used to carry out the method of the present invention, with additional or alternative pages bearing functions, features, and offerings relevant to the particular business of retail unit 14.

The method of the present invention described in association with FIGS. 5-7 can be applied to a non-restaurant setting. In this case, items listed on menu page 170 will not be limited to food items, but will include any type of item identified by any type of retail unit 14. Retail unit 14 chooses which items to list and how they will be displayed on menu page 170. For stores with large inventory and many types of goods or services, retail unit 14 optionally can provide a search function permitting the consumer to submit a search request for a particular item.

A method of the present invention for transacting on-site or near-site retail purchases places the power and control of retail purchasing in the hands of the consumer and the retailer can insure convenient and efficient communication during the transaction. With this method, subscription to a centralized ordering service, telecommunications network, Internet service provider or portal, can be avoided. Finally, electronic payment options save time and obviate the need to carry cash.

FIG. 8 illustrates a system 200 for carrying out a method of identifying and/or transacting wireless on-site or near-site retail purchases in a multiple retail unit center, according to a method of the present invention. In particular, in this method, a consumer can avoid the trial and error searching for desired items at a retail shopping center. Instead, using system 200, which includes mobile computing device 202 and multiple retail center 204, the consumer can request a retailer to identify items available for purchase at their store prior to the consumer searching the entire retail shopping center for those items.

Mobile computing device 202 has generally the same features and attributes of mobile computing device 12 and mobile computing device 102. Retail center 204 includes retail units 206A-E and electronic communication center 208 including wireless module 209. Retail units 206 and electronic communication center 208 have generally the same features and attributes as retail unit 14 and 104, except where noted. Retail units 206B, 206C are in electronic communication with electronic communication center 208 of retail center 204 via wired transmission pathway 210. Retail units 206A, 206D, and 206E are in electronic communication with electronic communication center 208 of retail center 204 via wireless transmission pathway 212.

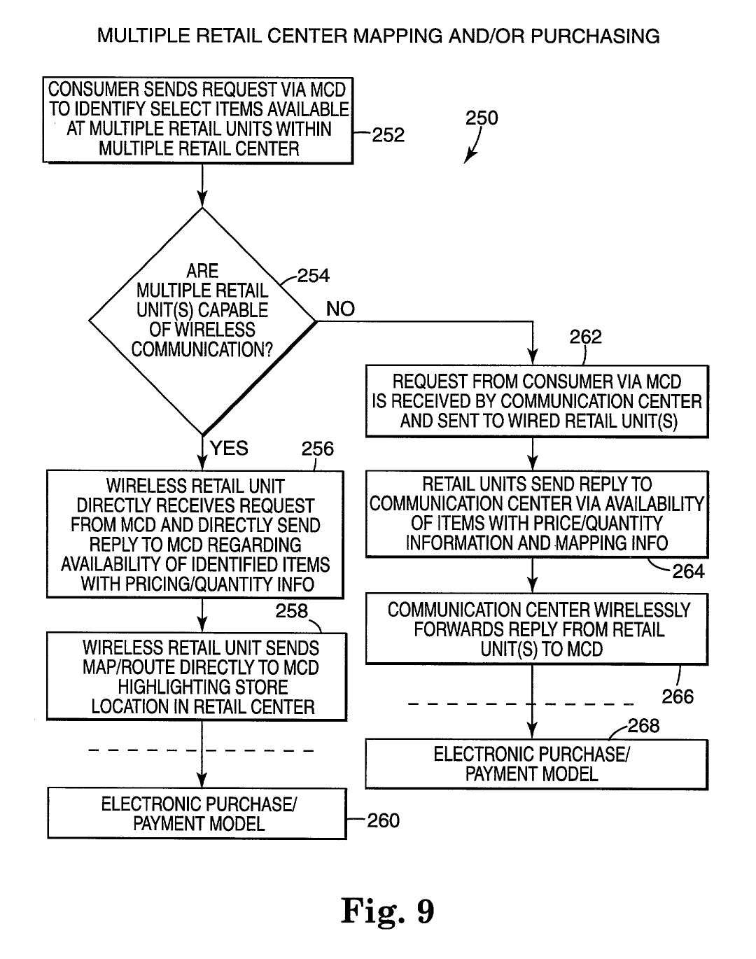

A method 250 of identifying and/or transacting retail purchases in retail center 200 (FIG. 8) according to an embodiment of the present invention is schematically illustrated in FIG. 9. As shown in FIG. 9, the first step of the method includes a consumer sending a request via mobile computing device 202 to identify select items for purchase at multiple retail units 206 within multiple retail center 204 (step 252). If any of the multiple retail units 206 are capable of direct wireless communication with mobile computing device 202 (such as wireless retail units 206(A, D, E)), then those stores directly receive the request from the consumer's mobile computing device 202 (step 256). In response, retail units 206(A, D, E) directly send a reply to the consumer at mobile computing device 202 regarding the availability of identified items and optionally may including pricing and quantity information with the reply. Wireless retail units 206 (A, D, E) also can optionally send a map or routing information directly to mobile computing device 202 highlighting location of retail units 206 (A, D, E) in retail center 204 (step 258). Finally, the method includes following electronic purchase/payment model 260. Model 260 is generally the same as steps 56 through 68 illustrated and described for consumer pathway 52 in association with FIG. 2 (step 260).

For those retail units that are not capable of wireless communication, the initial request from the consumer made with mobile computing device 202 is received by electronic communication center 208 of retail center 204. The request is then forwarded to wired retail units 206 (B, C) via wired pathway 210 (step 262). Retail units 206 (B, C) send a reply to communication center 208 regarding the availability of the items requested. The reply can optionally include pricing and quantity information, as well as store mapping information (step 264). Electronic communication center 208 then wirelessly forwards the reply from the retail unit 206 (B, C) to the consumer's mobile computing device 202 (step 266). Finally, the method includes following electronic purchase/payment model 268, which is generally the same as steps 72 through 86 that are illustrated and described for retail pathway 53 in association with FIG. 3 (step 260). However, for wired retail units 206 (B, C) electronic communication center 208 must function as a communication intermediary to complete the wireless electronic payment sent from mobile computing device 202.

Accordingly, when possible, mobile computing device 202 communicates directly with retail units 206 (e.g., 206 A, D, E) that are capable of direct wireless communication. However, electronic communication center 208 of retail center 204 compensates for wired-only retail units 206 (B, C) by providing the necessary wireless communication link to mobile computing device 202. Moreover, to simplify wireless communication for retail units 206 (A, D, E), electronic communication center 208 also optionally provides mapping and navigational information to mobile computing device 202. This feature reduces the demands on retail units 206(A, D, E) for communicating with mobile computing device 202. However, in the absence of electronic communication center 208, retail units 206(A, D, E) can provide that information on their own.

Mobile computing device 202, as used in the method 250 and system 200 for transacting purchases in a retail center, uses functions and screens similar to those shown in FIGS. 5-7, with the screens and functions being modified to suit the particular retail environment.

A method and system of the present invention for identifying and/or transacting wireless on-site or near-site retail purchases carries many advantageous features. First, consumers and retail businesses can streamline transactions and improve communication. For example, in the method of driveup ordering from a restaurant, consumers using mobile computing devices can place an order without submitting themselves to the awkard, sometimes annoying, verbal exchange at drive-up ordering stations. Second, consumers can electronically pay for their order at the same time. In another example, rather than undergo a long trial and error search process for desired items in a retail shopping center, consumers can quickly determine which stores have the items they like and determine where those stores are located. This method will result in an efficient path through the shopping center. Consumers can even pre-buy the goods so that the purchase is complete as the consumer arrives at the retail unit.

In both of these examples, a mobile computing device such as a personal digital assistant (PDA) is transformed from a generally passive information device into an interactive purchasing device that directly communicates with retail businesses while on-site or near-site. Since the method uses multiple known wireless communication protocols, including those which allow direct device-to-device communication, the method and system of the present invention can operate independent of the internet, independent of telecommunication providers and networks, and independent of a centralized retail office or ordering service. For these reasons, the method and system of the present invention will expand the role of the mobile computing device in consumers' daily interaction in the retail world. Finally, the method is not limited to drive-up ordering or shopping at a mall. Rather, the mobile computing device can be used to identify and/or transact any on-site or near-site retail purchase of any type of goods or services so long as the retail unit offers wireless communication for purchasing.

While the invention has been described with reference to specific embodiments, the description is illustrative and is not to be construed as limiting the scope of the invention. Various other modifications and changes may occur to those skilled in the art without departing from the spirit and scope of the invention.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of wirelessly electronically identifying an on-site or near-site retail purchase from a retail unit using a mobile computing device comprising:
communicating via a direct, wireless communication link between the mobile computing device and the retail unit to perform the following actions:
receiving at the mobile computing device a listing from the retail unit; and
transmitting from the mobile computing device a purchase request to the retail unit to order selected items from the listing.

2. The method of claim 1, further comprising the step of sending a request from the mobile computing device to the retail unit to receive a listing of items available for purchase.

3. The method of claim 1, further comprising the step of receiving at the mobile computing device from the retail unit a confirmation of the ordered items.

4. The method of claim 1, further comprising picking up the ordered items from the retail unit.

5. The method of claim 1, further comprising paying for the ordered items via the mobile computing device.

6. The method of claim 5, wherein the paying step further comprises sending a secure electronic payment to the retail unit for the ordered items.

7. The method of claim 6, wherein the step of sending secure payment further comprises paying electronically by at least one of a credit card, a debit card, an electronic funds transfer, and a checking account.

8. The method of claim 1, further comprising:
defining the retail unit as a drive-up restaurant; and
providing the listing as a menu of food items available for purchase.

9. The method of claim 1, wherein the communicating step further comprises establishing an independent direct electronic link between the mobile computing device and the retail unit for permitting wireless electronic communication therebetween independent of a communication network.

10. The method of claim 9, further comprising establishing the communication link during the step of requesting a listing of items for purchase.

11. The method of claim 9, further comprising establishing the communication link automatically upon the mobile computing device and an electronic communication module of the retail unit being in close proximity to each other.

12. The method of claim 11, further comprising performing the step of receiving the listing of available items immediately upon establishment of the communication link.

13. The method of claim 1, wherein the mobile computing device comprises at least one of a personal digital assistant, a laptop computer, and a mobile phone.

14. The method of claim 1, wherein mobile computing device includes voice recognition capability.

15. The method of claim 1, further comprising providing the mobile computing device with one or more active display pages for activating functions to transact a retail purchase with the retail unit including at least the following functions: menu request, item selection, order request, and payment selection including authorization.

16. A method of wirelessly electronically identifying an on-site or near-site retail purchase within a multiple retail unit center using a mobile computing device comprising:
wirelessly electronically communicating between the mobile computing device and one or more retail units within the retail center to perform following functions:
sending a request from the mobile computing device to the retail units within the retail unit center to identify select items available for purchase from the retail units within the retail center; and
receiving at the mobile computing device from at least one of the retail units an identification of select items available for purchase at the retail unit.

17. The method of claim 16, further comprising sending a request from the mobile computing device to the retail unit to purchase the identified items.

18. The method of claim 17, further comprising receiving at the mobile computing device a confirmation from the retail unit of purchase of the items.

19. The method of claim 18, further comprising sending electronic secure payment for the purchased items from the mobile computing device to the retail unit.

20. The method of claim 16, further comprising receiving at the mobile computing device mapping and routing information sent from the retail units regarding location of each retail unit in the retail center.

21. The method of claim 16, further comprising establishing a wireless electronic communication link between the mobile computing device and an electronic communication center of the retail center in addition to communication between the mobile computing device and the retails units.

22. A system for identifying and transacting a wireless electronic on-site retail purchase comprising:
a mobile computing device;
a retail unit including a wireless communication module for direct wireless electronic communication with the mobile computing device; and
a direct wireless electronic communication link between the mobile computing device and the retail unit that is activated by at least one of selective activation by the mobile computing device and by automatic activation upon the mobile computing device and the retail unit upon arrival of the computing device upon the premises of the retail unit.

23. A wireless purchasing system comprising:
a communication module located at a retail unit; and
a wireless appliance configured to establish a communication link with the retail unit via the communication module, receive a listing of items from the retail unit, transmit a purchase request to the retail unit of ordered selected items from the listing, and receive a confirmation of the ordered selected items.
